(19) United States
(12) Patent Application Publication
(10) Pub. No.: US 2024/0413961 A1
(43) Pub. Date: Dec. 12, 2024

(54) COHERENT FREQUENCY BANDS RECEIVE OPERATION

(71) Applicant: Google LLC, Mountain View, CA (US)

(72) Inventors: Ming Sun, Santa Clara, CA (US); Fei He, Sunnyvale, CA (US)

(21) Appl. No.: 18/702,551

(22) PCT Filed: Dec. 30, 2021
(86) PCT No.: PCT/US2021/073194

§ 371 Date: Apr. 18, 2024

(51) Int. Cl. H04L 5/14; H04B 1/16; H04L 5/00

(52) U.S. Cl. CPC H04L 5/14; H04B 1/16; H04L 5/0048

(57) ABSTRACT

An example method includes selecting, by a computing device, a plurality of frequency bands for communicating with at least one node of a wireless network, each of the plurality of frequency bands corresponding to a respective communication channel; receiving, by the computing device, a frequency block that encompasses the selected plurality of frequency bands; demodulating, by the computing device and to a baseband domain, the frequency block; and decoding, by the computing device and based on the demodulated frequency block, a respective signal for each of the plurality' of frequency bands.

### BACKGROUND

A wireless network may use several frequency bands with associated bandwidths. In some examples, different spectrum usage techniques, such as Frequency Division Duplex (FDD) and Time Division Duplex (TDD), may be employed to enhance performance of the network. In general, FDD uses separate frequencies for uplink and downlink, and TDD uses a single frequency for both uplink and downlink.

### SUMMARY

A computing device (sometimes referred to as “user equipment” (UE)) may communicate with a wireless network to uplink and downlink data. In some examples, a wireless network device may use carrier aggregation (CA) to increase available bandwidth to a computing device. For instance, CA may increase the number of frequency bands assigned to a computing device in a wireless network, thereby increasing available bandwidth.

However, the use of CA may include one or more disadvantages. As one example, when a computing device is assigned frequency bands that are contiguous, the computing device may need dedicated receiver chains as well as antennas for each of the frequency bands. For instance, when a computing device is assigned to simultaneously operate in a FDD band (e.g., FDD band 7, the downlink portion of which spans 2620 MHz to 2690 MHz) and/or a TDD band (e.g., TDD band 38, which spans 2570 MHz to 2620 MHz), the computing device may need a first receiver chain to process the FDD band and a second receiver chain to process the TDD band. This need for a potentially large number of receiver chains may add undesirable cost, printed circuit board (PCB) area, and/or power consumption.

In accordance with one or more techniques of this disclosure, a computing device may use a receiver chain (e.g., from antenna to analog-digital converter) to process multiple frequency bands simultaneously. For instance, the computing device may include a receiver chain configured to receive and process (e.g., demodulate and decode) a frequency block that encompasses FDD band 7 and TDD band 38 downlink signals (e.g., spanning 2570 MHz to 2690 MHz). In this way, this disclosure may enable a reduction in cost, PCB area, and power consumption of radio hardware in the computing device.

In one example, a method includes: selecting, by a computing device, a plurality of frequency bands for communicating with at least one node of a wireless network, each of the plurality of frequency bands corresponding to a respective communication channel; receiving, by the computing device, a frequency block that encompasses the plurality of frequency bands; demodulating, by the computing device and to a baseband domain, the frequency block; and decoding, by the computing device and based on the demodulated frequency block, a respective signal for each of the plurality of frequency bands.

In one example, a computing device includes: a receiver chain including: one or more antennas; and a downconverter; and one or more processors configured to: select a plurality of frequency bands for communicating with at least one node of a wireless network, each of the plurality of frequency bands corresponding to a respective communication channel; cause the receiver chain to receive, via the one or more antennas, a frequency block that encompasses the plurality of frequency bands; cause a downconverter to demodulate, to a baseband domain, the frequency block; and decode, based on the demodulated frequency block, a respective signal for each of the plurality of frequency bands.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram of an example system including a computing device configured to operate a plurality of frequency bands simultaneously in accordance with techniques of this disclosure.

FIG. 2 is a conceptual diagram of an example receiver chain of a computing device configured to operate a plurality of frequency bands simultaneously in accordance with techniques of this disclosure.

FIG. 3 is a conceptual diagram illustrating further details of an example computing device configured to operate a plurality of frequency bands simultaneously in accordance with techniques of this disclosure.

FIG. 4 is a flow diagram of an example operation of a computing device in accordance with techniques of this disclosure.

### DETAILED DESCRIPTION

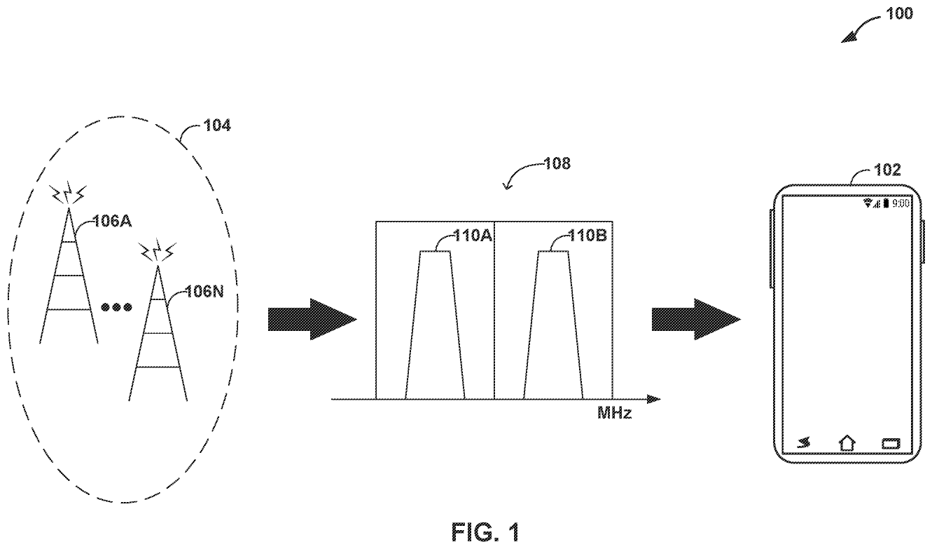

FIG. 1 is a conceptual diagram of an example system 100 including a computing device 102 configured to operate a plurality of frequency bands simultaneously in accordance with techniques of this disclosure. As shown in FIG. 1, system 100 includes computing device 102 and wireless network 104.

In the example of FIG. 1, computing device 102 represents an individual mobile or non-mobile computing device. Examples of computing device 102 include a mobile phone, a tablet computer, a laptop computer, a desktop computer, a server, a mainframe, a set-top box, a television, a wearable device (e.g., a computerized watch, computerized eyewear, computerized headphones, computerized gloves, etc.), a home automation device or system (e.g., an intelligent thermostat or home assistant device), a personal digital assistant (PDA), a gaming system, a media player, an e-book reader, a mobile television platform, an automobile navigation or infotainment system, or any other type of mobile, non-mobile, wearable, and non-wearable computing device configured in accordance with techniques of this disclosure.

Wireless network 104 (“network 104”) may represent components configured to wirelessly exchange data with computing devices, such as computing device 102. As shown in FIG. 1, wireless network 104 may include one or more nodes 106A-106N (collectively, “nodes 106”) of network 104. Nodes 106 may represent any type of radio network node or any network node. Examples of nodes 106 may include Node B, base station (BS), multi-standard radio (MSR) radio node (e.g., MSR BS), gNB, eNode B (eNB), network controller, radio network controller (RNC), base station controller (BSC), etc.

Computing device 102 may communicate with a wireless network 104 over a wireless interface. For example, computing device 102 may transmit wireless signals (containing, e.g., voice traffic, data traffic, control signals, etc.) to and receive wireless signals from at least one of nodes 106. The wireless signals may be divided into frequency bands 110 that each correspond to a respective communication channel. For instance, frequency bands 110 may include a first frequency band 110A and a second frequency band 110B. Each of frequency bands 110 may correspond to a respective communication channel. Each of the respective communication channels may facilitate the transmission of control information (e.g., signaling) by handling data streams. Examples of communication channels may include physical control channels (PCCH), common control channels (CCCH), etc.

In some examples, system 100 may employ carrier aggregation (CA). The use of CA may provide one or more advantages, such as increasing available bandwidth between computing device 102 and wireless network 104. The increase in available bandwidth may be due to a greater number of frequency bands being assigned to computing device 100 in network 104 as well as other factors, such as better resource utilization and improved load balancing. System 100 may use CA by assigning computing device 102 FDD and/or TDD bands that computing device 102 is configured to simultaneously operate. For instance, computing device 102 may be assigned to simultaneously operate in FDD band 7, the downlink portion of which spans 2620 MHz to 2690 MHz, and TDD band 38, which spans 2570 MHz to 2620 MHz. In another example, computing device 102 may be assigned to simultaneously operate in TDD band 48, which spans 3550 MHz to 3700 MHZ, and new radio (NR) TDD band 77, which spans 3300 MHz to 4200 MHz.

Although the use of CA can be advantageous, the use of CA can also include one or more disadvantages. As one example, when computing device 102 is assigned frequency bands that are contiguous, computing device 102 may need dedicated receiver chains as well as antennas for each of the frequency bands. For instance, when a computing device is assigned to simultaneously operate in FDD band 7 and TDD band 38, computing device 102 may need a first receiver chain to process FDD band 7 and another receiver chain to process TDD band 38. This need for a large number of receiver chains may add undesirable cost, PCB area, and/or power consumption.

In accordance with one or more techniques of this disclosure, computing device 102 may use a receiver chain (e.g., hardware that processes signals received from antenna to analog-to-digital conversion) to process multiple frequency bands simultaneously.

Computing device 102 may select a plurality of frequency bands 110 for communicating with at least one node of network 104. For example, computing device 102 may select first frequency band 110A, which may be FDD band 7, and second frequency band 110B, which may be TDD band 38. In some cases, computing device 102 may select frequency bands 110 for communicating with a single node of network 104. In other words, the radio hardware for each carrier signal may be co-located at a single node.

In some examples, computing device 102 may select more than two frequency bands for communicating with network 104. For example, computing device 102 may select three, four, five, etc., frequency bands. In addition, although primarily described herein with respect to FDD band 7 and TDD band 38, the techniques of this disclosure may be applied to frequency bands other than FDD band 7 and TDD band 38, such as TDD band 48 and NR TDD band 77. Indeed, the techniques of this disclosure may be applied even when the frequency bands selected by computing device 102 do not include a combination of FDD and TDD bands (e.g., all of the selected frequency bands are FDD bands, or all of the selected frequency bands are TDD bands). Additionally, frequency bands 110 may be contiguous or non-contiguous.

In any case, as opposed to using separate receive chains to separately process frequency bands 110A and 110B, computing device 102 may use a single receive chain to process frequency block 108 that encompasses frequency bands 110A and 110B. In some examples, the width of frequency block 108 is equal to or less than 200 megahertz (MHz). Such a width of frequency block 108 may limit the processing power required to demodulate and decode frequency block 108 as described herein. However, it should be understood that the width of frequency block 108 may be greater than 200 MHz.

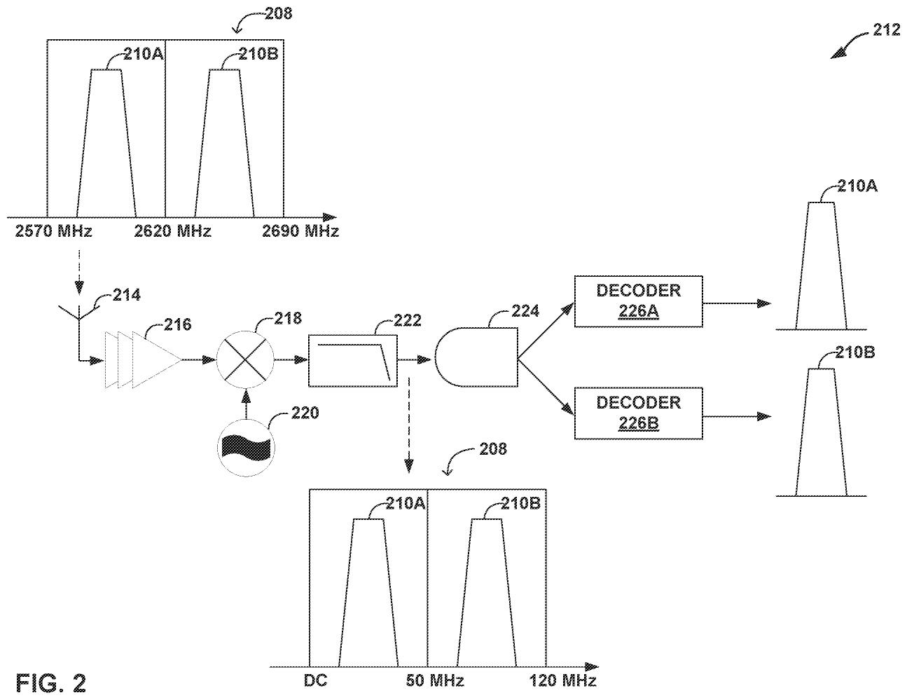

Computing device 102 may receive frequency block 108 and demodulate (e.g., downconvert) frequency block 108 to a baseband domain. For example, as described in greater detail with respect to FIG. 2, computing device 102 may downconvert frequency block 108, apply a baseband filter to frequency block 108, and apply an analog-to-digital converter to frequency block 108. Responsive to demodulation of frequency block 108, computing device 102 may decode a respective signal for each of frequency bands 110 (e.g., a first signal for frequency band 110A and a second signal for frequency band 110B). In this way, computing device 102 may use a receiver chain to process frequency bands 110 simultaneously, thereby potentially enabling a reduction in cost, PCB area, and power consumption of radio hardware in computing device 102.

FIG. 2 is a conceptual diagram of an example receiver chain 212 of a computing device (e.g., computing device 102) configured to receive a frequency block 208 and operate a plurality of frequency bands, such as frequency bands 210A-210B (collectively, “frequency bands 210”), simultaneously in accordance with techniques of this disclosure. Frequency block 208 of FIG. 2 is described below as an example of frequency block 108 illustrated in FIG. 1, and frequency bands 210 of FIG. 2 are described below as an example of frequency bands 110 illustrated in FIG. 1.

A node, such as node 106A, may transmit frequency block 208, and a computing device, such as computing device 102, may receive frequency block 208 via receiver chain 212. Frequency block 208 may encompass a plurality of frequency bands 210. For example, as shown in FIG. 2, frequency block 208 may encompass band 7 and band 38. Accordingly, in the example of FIG. 2, frequency block 208 has a width of 120 MHZ, the minimum frequency being 2570 MHz and the maximum frequency being 2690 MHZ.

As shown in FIG. 2, receiver chain 212 includes an antenna 214, a low-noise amplifier 216 (“LNA 216”), a downconverter 218, a local oscillator 220, a baseband filter 222, an analog-to-digital converter 224 (“ADC 224”), and one or more decoders 226, such as decoder 226A and decoder 226B. Receiver chain 212 may receive, demodulate, and decode frequency block 208.

Antenna 214 of receiver chain 212 may be configured to receive (and transmit) signals, such as frequency block 208. LNA 216 may amplify a weak signal (e.g., without significantly degrading the signal-to-noise ratio) generated by antenna 214 when antenna 214 receives frequency block 208. Additionally, antenna 214 may be configured to receive or otherwise obtain information (relating to, e.g., selecting channels, resource blocks, and waveform mission critical services (MCS) configurations) from at least one of nodes 106 for demodulating frequency block 208 to the baseband domain. In some examples, the computing device may use this information to configure and tune downconverter 218, local oscillator 220, baseband filter 222, etc.

Downconverter 218 may be configured to downconvert frequency block 208 to the baseband domain as a single block. The baseband domain may correspond to the downlink portion of frequency bands 210. For instance, the baseband domain may encompass frequencies ranging from 0 MHz (“DC”) to 120 MHz, where the minimum frequency of 0 MHz corresponds to a frequency of 2570 MHz, and the maximum frequency of 120 MHz corresponds to a frequency of 2690 MHz.

In some examples, downconverter 218 may decrease a frequency of frequency block 208 by an amount such that the minimum frequency is 0 MHz after downconversion and decrease the other frequencies of frequency block 208 by the same amount. For example, if frequency block 208 has a minimum frequency of 2570 MHz and a maximum frequency of 2690 MHz, downconverter 218 may decrease every frequency of frequency block 208 by 2570 MHz, resulting in the downconverted minimum frequency being 0 MHz and the downconverted maximum frequency being 120 MHz.

Downconverter 218 may include, use, or otherwise operate in conjunction with local oscillator 220. Local oscillator 220 may be configured to change (e.g., decrease) the frequency of frequency block 208 (as well as frequency bands 210 encompassed therein). For example, downconverter 218 and local oscillator 220 may operate to downconvert a frequency of 2570 MHz to 0 Mhz and a frequency of 2690 MHz to 120 MHz. In some examples, local oscillator 220 may be configured to be in the center of frequency bands 210.

Baseband filter 222 may be configured to remove noise or other undesirable components, features, or frequencies from frequency block 208. For example, if after being downconverted to a baseband domain, frequency block 208 has a minimum frequency of 0 MHz and a maximum frequency of 120 MHz, baseband filter 222 may remove all frequencies greater than 120 MHz. In other words, baseband filter 222 may be configured to remove (e.g., decrease the amplitude of) all frequencies that are not within the baseband domain.

ADC 224 may be configured to convert an analog signal into a digital signal. In some examples, ADC 224 may be configured to convert frequency block 208 into a plurality of digital signals, each digital signal of the plurality of digital signals corresponding to a respective frequency band of frequency bands 210. ADC 224 may be implemented as integrated circuits (ICs), such as metal-oxide-semiconductor (MOS) mixed-signal integrated circuit chips that integrate both analog and digital circuits.

Decoders 226 may be configured to decode frequency block 208 into a respective signal for each of frequency bands 210. For instance, in the example shown in FIG. 2, decoder 226A may decode frequencies within a range of about 0 MHz to about 50 MHz as corresponding to frequency band 210A, and decoder 226B may decode frequencies within a range of about 50 MHz to about 120 MHz as corresponding to frequency band 210B. Additionally or alternatively, decoders 226 may decode the respective signal for each of frequency bands 210 by using channel information obtained from the communication channel corresponding to frequency bands 110. In some examples, decoders 226 may decode the respective signal for each of frequency bands 210 from the plurality of digital signals outputted by ADC 224.

Although receiver chain 212 is primarily described herein as processing frequency block 208 by receiving, amplifying, downconverting, filtering, and decoding frequency block 208 to, some of these steps are optional and therefore not essential to the techniques of this disclosure. For example, amplifying and filtering frequency block 208 may not be required when processing frequency block 208. Furthermore, although FIG. 2 illustrates a sequence of steps, one or more of the steps may be performed in a different order and/or concurrently with one or more other steps. Thus, the techniques of this disclosure are not limited to the example of FIG. 2, and other examples are contemplated.

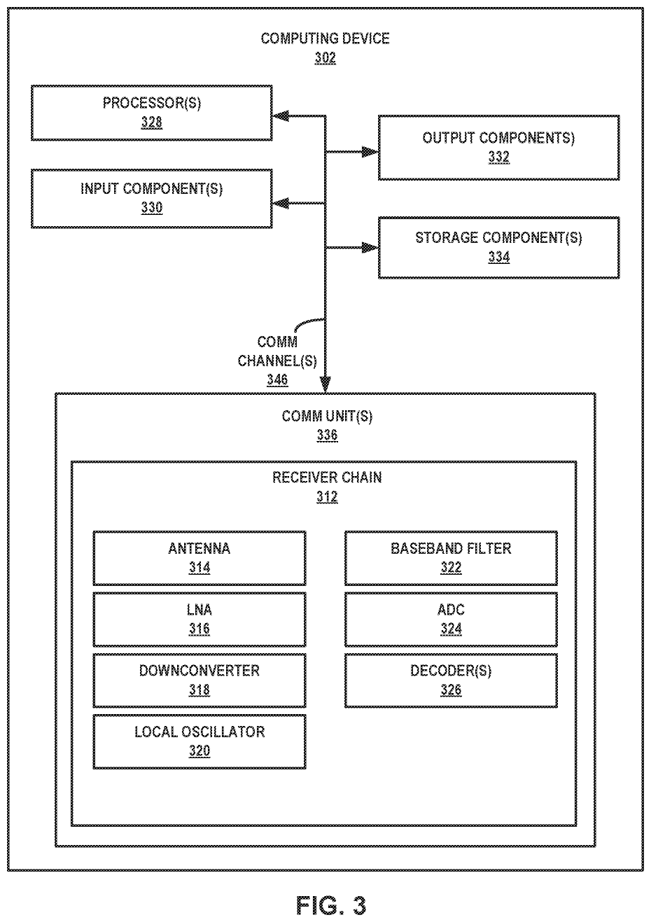

FIG. 3 is a conceptual diagram illustrating further details of an example computing device 302 configured to operate a plurality of frequency bands simultaneously in accordance with techniques of this disclosure. Computing device 302 of FIG. 3 is described below as an example of computing device 102 illustrated in FIG. 1. FIG. 3 illustrates only one particular example of computing device 302, and many other examples of computing device 302 may be used in other instances and may include a subset of the components included in example computing device 302 or may include additional components not shown in FIG. 3.

As shown in the example of FIG. 3, computing device 302 includes one or more processors 328, one or more input components 330, one or more output components 332, one or more storage components 334, and one or more communication units 336. Communication units 336 may include a receiver chain 312. Receiver chain 312 of FIG. 3 is described below as an example of receiver device 212 illustrated in FIG. 2.

Communication channels 346 (“COMM channels 346”) may interconnect each of the components 328, 330, 332, 334, and/or 336 for inter-component communications (physically, communicatively, and/or operatively). In some examples, COMM channels 346 may include a system bus, a network connection, an inter-process communication data structure, or any other method for communicating data.

One or more processors 328 may implement functionality and/or execute instructions within computing device 302. For example, processors 328 on computing device 302 may receive and execute instructions stored by storage components 336. The instructions executed by processors 328 may cause computing device 302 to store information within storage components 336 during program execution. Examples of processors 328 include application processors, display controllers, sensor hubs, and any other hardware configured to function as a processing unit.

One or more input components 330 of computing device 302 may receive input. Examples of input are tactile, audio, and video input. Input components 330 of computing device 302, in one example, includes a presence-sensitive display, touch-sensitive screen, mouse, keyboard, voice responsive system, video camera, microphone or any other type of device for detecting input from a human or machine. Input components 330 may function as user interface components of computing device 302.

One or more output components 332 of computing device 302 may generate output. Examples of output are tactile, audio, and video output. Output components 332 of computing device 302, in one example, includes a presence-sensitive display, sound card, video graphics adapter card, speaker, cathode ray tube (CRT) monitor, liquid crystal display (LCD), haptic motors, linear actuating devices, or any other type of device for generating output to a human or machine. Output components 332 may function as user interface components of computing device 302.

One or more storage components 334 within computing device 302 may store information for processing during operation of computing device 302. In some examples, storage components 334 may be configured for temporary memory, meaning that a primary purpose of storage components 334 is not long-term storage. Storage components 334 on computing device 302 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 334, in some examples, also include one or more computer-readable storage media. Storage components 334 may be configured to store larger amounts of information than volatile memory. Storage components 334 may further be configured for long-term storage of information as non-volatile memory space and retain information after power on/off cycles. Examples of non-volatile memories include magnetic hard discs, optical discs, flash memories, or forms of electrically programmable memories (EPROM) or electrically erasable and programmable (EEPROM) memories.

One or more communication units 336 of computing device 302 may communicate with external devices via one or more wired and/or wireless networks by transmitting and/or receiving network signals on the one or more networks. Examples of communication units 336 include a network interface card (e.g., an Ethernet card), an optical transceiver, a radio frequency transceiver, a GPS receiver, or any other type of device that can send and/or receive information. Other examples of communication units 336 may include short wave radios, cellular data radios, wireless network radios, as well as universal serial bus (USB) controllers. In some examples, communication units 334 may use multiple-input and multiple-output (MIMO) techniques, such as 4×4 MIMO. In such examples, receiver chain 312 may be a 4×4 MIMO device.

Communication units 336 may include receiver chain 312. Receiver chain 312 may include an antenna 314, a LNA 316, a downconverter 318, a local oscillator 320, a baseband filter 322, an ADC 324, and a decoder 326. Antenna 314 of FIG. 3 is described below as an example of antenna 214 illustrated in FIG. 2. LNA 316 of FIG. 3 is described below as an example of LNA 216 illustrated in FIG. 2. Downconverter 318 of FIG. 3 is described below as an example of downconverter 218 illustrated in FIG. 2. Local oscillator 320 of FIG. 3 is described below as an example of local oscillator 220 illustrated in FIG. 2. ADC 324 of FIG. 3 is described below as an example of ADC 224 illustrated in FIG. 2. Decoders 326 of FIG. 3 are described below as an example of decoder 226A and decoder 226B illustrated in FIG. 2.

While illustrated in FIG. 3 as being discrete components within receiver chain 312, in some examples decoders 326 may be modules executable by processors 328. For instance, processors 328 may execute decoder modules (e.g., modules that implement functionality of decoders 326) that cause processors 328 to receive and decode the digital signals output by ADC 324.

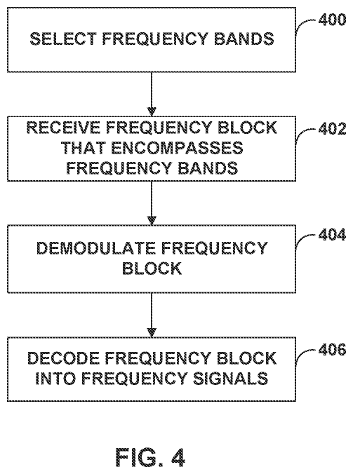

FIG. 4 is a flow diagram of an example operation of a computing device in accordance with techniques of this disclosure. The operations of the example computing device are described within the context of computing device 302 of FIG. 3.

As shown in FIG. 4, processors 328 of computing device 302 may select a plurality of frequency bands (e.g., frequency bands 210) for communicating with at least one node of a network (e.g., network 104) (400). For example, processors 328 may select first frequency band 210A, which may be FDD band 7, and second frequency band 210B, which may be TDD band 38. As discussed herein, in some examples, processors 328 may select the frequency bands as those that correspond to communication channels assigned to computing device 302.

Processors 328 of computing device 302 may cause receiver chain 312 to receive (via, e.g., antenna 314) a frequency block (e.g., frequency block 208) encompassing the selected frequency bands (402). Additionally, antenna 314 may receive or otherwise obtain information (relating to, e.g., selecting channels, resource blocks, and waveform mission critical services (MCS) configurations) from at least one of the nodes of the network for demodulating the frequency block to the baseband domain. In some examples, LNA 316 may amplify a signal generated by antenna 314 when antenna 314 receives the frequency block.

Processors 328 of computing device 302 may cause downconverter 318 of receiver chain 312 to demodulate the frequency block (404). Downconverter 318 may downconvert the frequency block to the baseband domain as a single block. In some examples, downconverter 318 may decrease a frequency of the frequency block by an amount such that the minimum frequency is 0 MHz after downconversion and decrease the other frequencies of the frequency block by the same amount. For example, if the frequency block has a minimum frequency of 2570 MHz and a maximum frequency of 2690 MHz, downconverter 318 may decrease every frequency of the frequency block by 2570 MHz, resulting in the downconverted minimum frequency being 0 MHz and the downconverted maximum frequency being 120 MHz.

In some examples, downconverter 318 may use local oscillator 320. Local oscillator 220 may change (e.g., decrease) the frequency of the frequency block (as well as frequency bands encompassed therein). For example, downconverter 318 and local oscillator 320 may operate to downconvert a frequency of 2570 MHz to 0 Mhz and a frequency of 2690 MHz to 120 MHz. In some examples, the local oscillator 320 may be in the center of the frequency bands.

In some examples, baseband filter 322 may remove noise or other undesirable components, features, or frequencies from the frequency block. For example, if after being downconverted to a baseband domain, the frequency block has a minimum frequency of 0 MHz and a maximum frequency of 120 MHz, baseband filter 322 may remove all frequencies greater than 120 MHz.

Decoders 326 may decode the frequency block into a respective signal for each of the selected frequency bands (406). For instance, decoders 326 may decode frequencies within a range of about 0 MHz to about 50 MHz as corresponding to frequency band 210A, and decoders 326 may decode frequencies within a range of about 50 MHz to about 120 MHz as corresponding to frequency band 210B. Additionally or alternatively, decoders 326 may decode the respective signal for each of the frequency bands by using channel information obtained from the communication channel corresponding to frequency bands 110. In some examples, decoders 326 may decode the respective signal for each of the frequency bands from the plurality of digital signals outputted by ADC 324.

The following numbered examples may illustrate one or more aspects of the disclosure:

Example 1: A method includes selecting, by a computing device, a plurality of frequency bands for communicating with at least one node of a wireless network, each of the plurality of frequency bands corresponding to a respective communication channel; receiving, by the computing device, a frequency block that encompasses the plurality of frequency bands; demodulating, by the computing device and to a baseband domain, the frequency block; and decoding, by the computing device and based on the demodulated frequency block, a respective signal for each of the plurality of frequency bands.

Example 2: The method of example 1, wherein the plurality of frequency bands includes a frequency division duplex band and a time division duplex band.

Example 3: The method of example 1, wherein the plurality of frequency bands includes at least two frequency bands that are contiguous.

Example 4: The method of example 1, wherein the plurality of frequency bands includes band 7 and band 38.

Example 5: The method of example 1, wherein the plurality of frequency bands includes band 48 and new radio (NR) band 77.

Example 6: The method of example 1, wherein the plurality of frequency bands includes at least two frequency bands that are non-contiguous.

Example 7: The method of example 1, wherein demodulating the frequency block to the baseband domain includes downconverting, by the computing device, the frequency block as a single block.

Example 8: The method of example 7, wherein downconverting the frequency block to the baseband domain includes using, by the computing device, a local oscillator in the center of the frequency block.

Example 9: The method of example 8, further includes converting, via an analog-to-digital converter, the downconverted frequency block into a plurality of digital signals, each digital signal of the plurality of digital signals corresponding to a respective frequency band of the plurality of frequency bands, wherein decoding the respective signal for each of the plurality of frequency bands includes: decoding, from the plurality of digital signals, the respective signals for each of the plurality of frequency bands.

Example 10: The method of example 1, wherein the computing device receives the frequency block via a single 4×4 multiple input, multiple output (MIMO) device.

Example 11: The method of example 10, wherein selecting the plurality of frequency bands for communicating with the at least one node of the wireless network includes: selecting the plurality of frequency bands for communicating with a single node of the wireless network.

Example 12: A computing device includes a receiver chain includes one or more antennas; and a downconverter; and one or more processors configured to: select a plurality of frequency bands for communicating with at least one node of a wireless network, each of the plurality of frequency bands corresponding to a respective communication channel; cause the receiver chain to receive, via the one or more antennas, a frequency block that encompasses the plurality of frequency bands; cause a downconverter to demodulate, to a baseband domain, the frequency block; and decode, based on the demodulated frequency block, a respective signal for each of the plurality of frequency bands.

Example 13: The computing device of example 12, wherein the plurality of frequency bands includes a frequency division duplex band and a time division duplex band.

Example 14: The computing device of example 12, wherein the plurality of frequency bands includes at least two frequency bands that are contiguous.

Example 15: The computing device of example 12, wherein the plurality of frequency bands includes band 7 and band 38.

Example 16: The computing device of example 12, wherein the plurality of frequency bands includes band 48 and new radio (NR) band 77.

Example 17: The computing device of example 12, wherein the plurality of frequency bands includes at least two frequency bands that are non-contiguous.

Example 18: The computing device of example 12, wherein the processors are configured to cause the downconverter to demodulate the frequency block to the baseband domain by downconverting the frequency block as a single block.

Example 19: The computing device of example 18, wherein the processors are configured to cause the downconverter to downconvert the frequency block to the baseband domain by using a local oscillator in the center of the frequency block.

Example 20: The computing device of example 19, further includes an analog-to-digital converter configured to convert the downconverted frequency block into a plurality of digital signals, each digital signal of the plurality of digital signals corresponding to a respective frequency band of the plurality of frequency bands, wherein the processors are configured to decode the respective signal for each of the plurality of frequency bands by decoding, from the plurality of digital signals, the respective signals for each of the plurality of frequency bands.

Example 21: The computing device of example 12, wherein the receiver chain includes a single 4×4 multiple input, multiple output (MIMO) device.

Example 22: The computing device of example 21, wherein the processors are configured to select the plurality of frequency bands for communicating with the at least one node of the wireless network by selecting the plurality of frequency bands for communicating with a single node of the wireless network.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of IC's (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples of the disclosure have been described. Any combination of the described systems, operations, or functions is contemplated. These and other examples are within the scope of the following claims.

1. A method comprising:
selecting, by a computing device, a plurality of frequency bands for communicating with at least one node of a wireless network, each of the plurality of frequency bands corresponding to a respective communication channel;
receiving, by the computing device, a frequency block that encompasses the plurality of frequency bands;
demodulating, by the computing device and to a baseband domain, the frequency block; and
decoding, by the computing device and based on the demodulated frequency block, a respective signal for each of the plurality of frequency bands.

2. The method of claim 1, wherein the plurality of frequency bands comprises a frequency division duplex band and a time division duplex band.

3. The method of claim 1, wherein the plurality of frequency bands comprises at least two frequency bands that are contiguous.

4. The method of claim 1, wherein the plurality of frequency bands comprises band 7 and band 38.

5. The method of claim 1, wherein the plurality of frequency bands comprises band 48 and new radio (NR) band 77.

6. The method of claim 1, wherein the plurality of frequency bands comprises at least two frequency bands that are non-contiguous.

7. The method of claim 1, wherein demodulating the frequency block to the baseband domain comprises downconverting, by the computing device, the frequency block as a single block.

8. The method of claim 7, wherein downconverting the frequency block to the baseband domain comprises using, by the computing device, a local oscillator in the center of the frequency block.

9. The method of claim 8, further comprising:
converting, via an analog-to-digital converter, the downconverted frequency block into a plurality of digital signals, each digital signal of the plurality of digital signals corresponding to a respective frequency band of the plurality of frequency bands,
wherein decoding the respective signal for each of the plurality of frequency bands comprises:
decoding, from the plurality of digital signals, the respective signals for each of the plurality of frequency bands.

10. The method of claim 1, wherein the computing device receives the frequency block via a single 4×4 multiple input, multiple output (MIMO) device.

11. The method of claim 10, wherein selecting the plurality of frequency bands for communicating with the at least one node of the wireless network comprises:
selecting the plurality of frequency bands for communicating with a single node of the wireless network.

12. A computing device comprising:
a receiver chain comprising:
one or more antennas; and
a downconverter; and
one or more processors configured to:
select a plurality of frequency bands for communicating with at least one node of a wireless network, each of the plurality of frequency bands corresponding to a respective communication channel;
cause the receiver chain to receive, via the one or more antennas, a frequency block that encompasses the plurality of frequency bands;
cause a downconverter to demodulate, to a baseband domain, the frequency block; and
decode, based on the demodulated frequency block, a respective signal for each of the plurality of frequency bands.

13. The computing device of claim 12, wherein the plurality of frequency bands comprises a frequency division duplex band and a time division duplex band.

14. The computing device of claim 12, wherein the plurality of frequency bands comprises at least two frequency bands that are contiguous.

15. The computing device of claim 12, wherein the plurality of frequency bands comprises band 7 and band 38.

16. The computing device of claim 12, wherein the plurality of frequency bands comprises band 48 and new radio (NR) band 77.

17. The computing device of claim 12, wherein the plurality of frequency bands comprises at least two frequency bands that are non-contiguous.

18. The computing device of claim 12, wherein the processors are configured to cause the downconverter to demodulate the frequency block to the baseband domain by downconverting the frequency block as a single block.

19. The computing device of claim 18, wherein the processors are configured to cause the downconverter to downconvert the frequency block to the baseband domain by using a local oscillator in the center of the frequency block.

20. The computing device of claim 19, further comprising:
an analog-to-digital converter configured to convert the downconverted frequency block into a plurality of digital signals, each digital signal of the plurality of digital signals corresponding to a respective frequency band of the plurality of frequency bands,
wherein the processors are configured to decode the respective signal for each of the plurality of frequency bands by decoding, from the plurality of digital signals, the respective signals for each of the plurality of frequency bands.

21. The computing device of claim 12, wherein the receiver chain comprises a single 4×4 multiple input, multiple output (MIMO) device.

22. The computing device of claim 21, wherein the processors are configured to select the plurality of frequency bands for communicating with the at least one node of the wireless network by selecting the plurality of frequency bands for communicating with a single node of the wireless network.
